(19) United States
(12) Patent Application Publication
(10) Pub. No.: US 2016/0084405 A1
(43) Pub. Date: Mar. 24, 2016

(54) ONLINE FULL STROKE TESTING OVERPRESSURIZATION SAFETY RELIEF VALVE

(71) Applicant: GEORGE PAUL BAKER, JR., Denham Springs, LA (US)

(72) Inventor: GEORGE PAUL BAKER, JR., Denham Springs, LA (US)

(21) Appl. No.: 14/494,628

(22) Filed: Sep. 24, 2014

(51) Int. Cl. F16K 37/00

(52) U.S. Cl. CPC F16K 37/0091; F16K 37/0083

(57) ABSTRACT

Cycling, self-checking, fail-open block valve system that continuously cycles such that the user of the block valve system can determine if the system is operational at all times. A dual port, tandem block valve body contains two block valves which alternate between full open and fully closed. The full open and full closing cycle is monitored for any changes, and the operator is alerted if one of the valves is not operating properly.

### BACKGROUND OF THE INVENTION

This invention relates in general to valves utilized in applications where it is desired that the block valve would fail in the open position. Applications will include all those where normal operation will require the valve to be closed, including those where the block valve is utilized as part of an emergency pressure relief system in industrial processes. This invention relates in particular to a dual plug, fail open block valve system that continuously cycles two valves between the open and closed positions, and enables the operator to know if there is a problem with operation of the valve system prior to its needed use in an emergency relief.

Industrial operations often include mechanical pressure relief valves that are utilized to release excessive pressure from vessels, reactors and piping prior to rupture and destruction of the process containment system. Other operations require that some inhibiting or squelching agent be blocked in until an appropriate point in the operation, where it is necessary the block valve work as designed when needed. Pressure relief valves are typically vented through piping routed to the atmosphere or to a scrubbing system where the process chemicals are neutralized and rendered harmless to personnel and the environment. One of the problems with these block valves and mechanical pressure relief valves is the infrequency of their use, which may result in a “frozen” valve, at the critical moment when it is needed. However, frequent testing of the valve to insure that it is not frozen, or in some manner not working properly is usually not an option, due to halting the process when a test is performed. Additionally, many reactive processes and other processes contain corrosive or dirty constituents that can clog or damage the block valve or the pressure relief valve and prevent it from operating properly, or can clog or block the vent or downstream piping. Blockage of the vent piping can prevent the pressure from being relieved even if the pressure relief valve is functioning correctly. The activation of the mechanical pressure relief valve will exacerbate clogging and usually requires the valve and its vent piping to be removed from service, cleared and cleaned, and the valve recalibrated and certified.

### SUMMARY OF THE INVENTION

The instant invention provides for a valve arrangement with ports in tandem that each contain a block valve, with a small interstitial volume contained between the two valves. Each block valve will cycle in sequence between open and closed. In addition, the valve system recognizes if one of the valves ceases to function properly, thus providing opportunity for the valve to be promptly repaired. This system is not intended to replace mechanical pressure relief valves but rather to be used in parallel with them. This system avoids the problem of unknown frozen or otherwise non-functional valves in emergency pressure relief service. Additionally, if the parallel mechanical pressure relief valve is isolated from corrosive or clogging process chemicals by means of a rupture disk, the pressure relief valve will be maintained in good condition, requiring fewer inspections and recalibrations over longer periods of time.

### BRIEF DESCRIPTION OF THE DRAWINGS

Reference will be made to the drawings wherein like parts are designated by like numerals and wherein:

FIG. 1 is a plan view of the self checking, fail open block valve of the instant invention;

FIG. 2 is an elementary wiring diagram for an electro-mechanical controller of the instant invention;

FIG. 3 is a simplified functional diagram for an electronic controller of the instant invention.

### DETAILED DESCRIPTION OF THE PREFERRED EMBODIMENTS

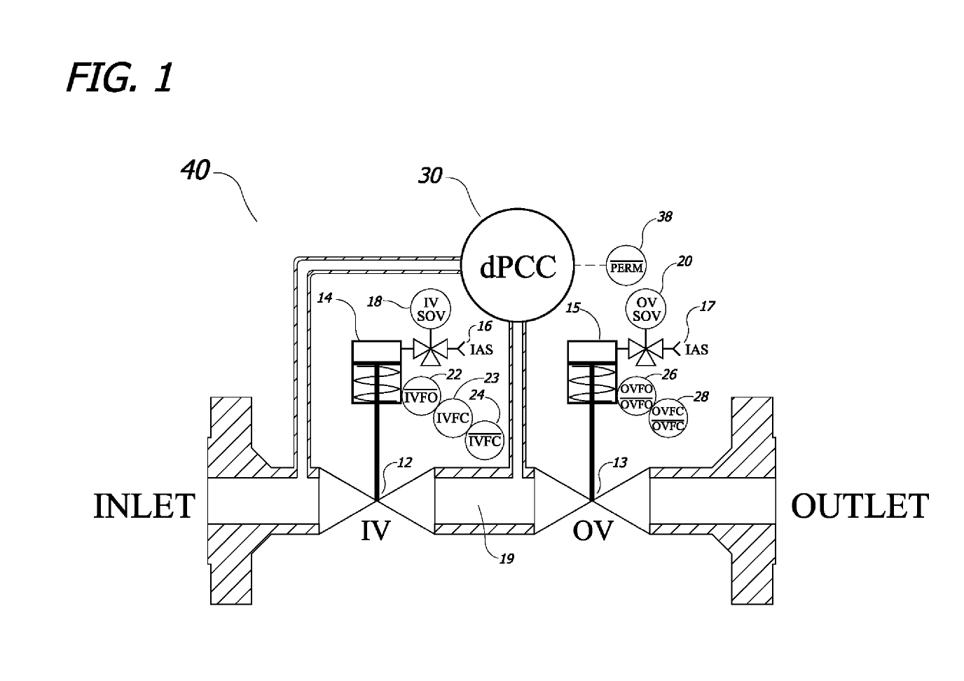

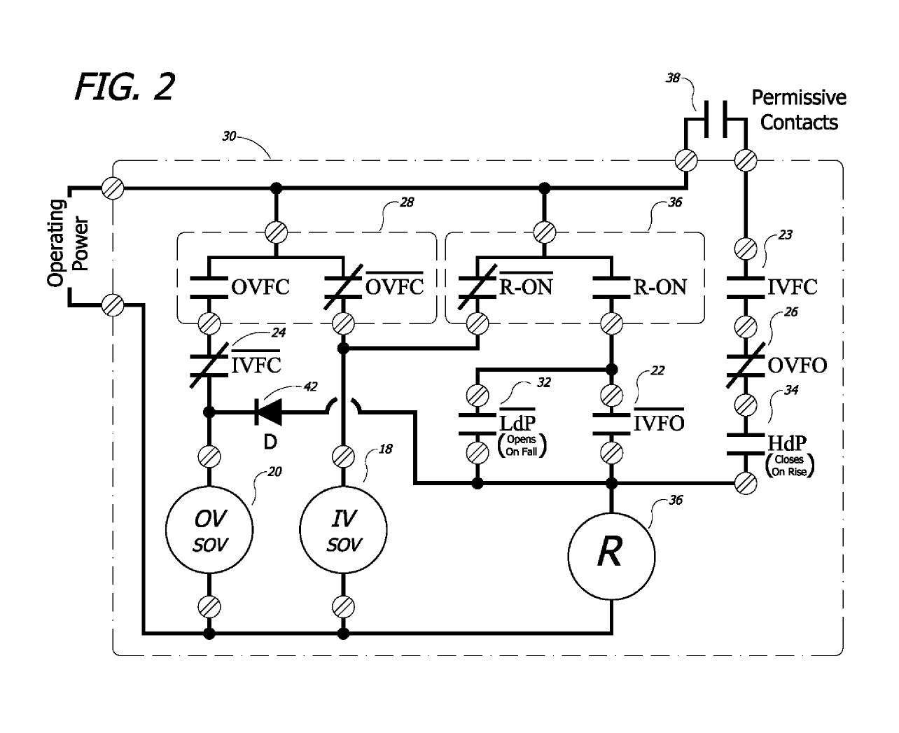

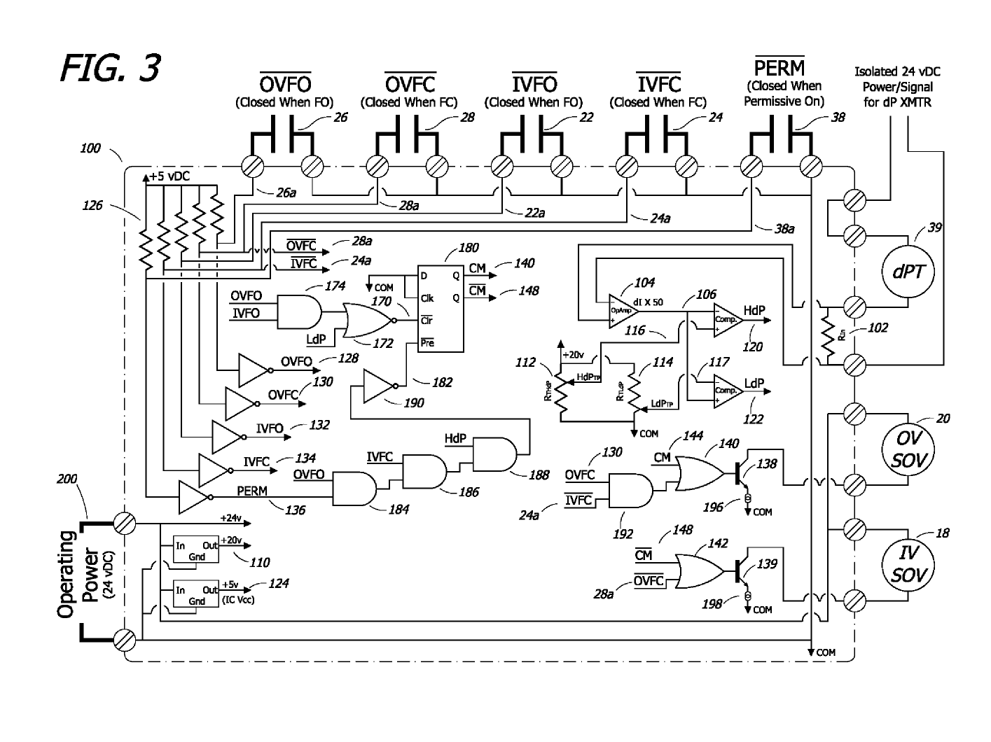

The invention concerns a cycling self checking fail open block valve and/or pressure relief element, such as a pressure safety valve, for use in critical safety pressure relief systems in industrial settings or any application requiring the use of a fail open block valve. Other types of valves and/or forms of actuation may be used with the invention, but the most common use in an industrial setting is likely to be quarter-turn block valves actuated by pneumatic pressure. The preferred embodiment consists of a valve body (40), with dual valve ports, designated herein as Inlet Valve (IV) and Outlet Valve (OV), (12 and 13, respectively). The valves may be connected in any process line in series (tandem), or may be part of a single piece of piping equipment as shown in FIG. 1. Each valve port and valve (12, 13) is independently operated by separate actuators (14, 15). Each actuator is powered by an instrument air supply (16, 17), and is piloted by separate solenoid operated valves (18 and 20). Each valve port and valve IV (12) and OV (13) has an independent “full open” and “fully closed” detection switches (22, 23, 24, 26 and 28), configured to meet the requirements of each controller type. A Differential Pressure Cycling Controller (see dPCC, 30) is associated with the valve assembly that may be an electro-mechanical type (FIG. 2), an electronic type (FIG. 3), or a programmable logic system. The electro-mechanical controller senses the differential pressure by means of a dual setpoint differential pressure switch [LdP_{bar} (32) and HdP (34) of FIG. 2] across the inlet valve (IV) (12). For the electronic type controller, a differential pressure transmitter [dPT (39) of FIG. 3] senses the differential pressure across the inlet valve IV (12). In both types of controllers, a “Permissive” (38) (see Permissive Contacts on FIG. 2 and FIG. 3), is provided so the correct operation of the valves can be checked when desired, while limiting the wear on the valve system once correct operation has been verified.

### Description of the Electro-Mechanical Controller

As illustrated in FIG. 2, the components contained within the differential Pressure Cycling Controller (dPCC) (30) include a Low differential Pressure switch (LdP_{bar}) (32), a High differential Pressure switch (HdP) (34) and a Single Pole Double Throw Relay (R) (36). In its initial state, no power is applied to the valve system from the logic output (see FIG. 2) and both valve ports and valves IV (12) and OV (13) are fully opened. In this state, no process pressure can be established nor maintained above the pressure in the vent/scrubber system to which the outlet of the valve system is connected. The Outlet Valve NOT Fully Closed contacts (OVFC_{bar}) (part of 28) will be closed, and the Outlet Valve Fully Closed contacts (OVFC) (part of 28) will be open. The Relay NOT On contacts (R-ON_{bar}) (part of 36) will be closed and the Relay On contacts (R-ON) (part of 36) will be open. The Inlet Valve Fully Closed contacts (IVFC) (23) will be open, and the Inlet Valve NOT Fully Closed contacts (IVFC_{bar}) (24) will be closed. The Outlet Valve Fully Open contacts (OVFO)(26) will be closed, and the Inlet Valve NOT Fully Open contacts (IVFO_{bar})(22) will be open. The NOT Low differential Pressure contacts (LdP_{bar}) (32), contained within the differential pressure switch will be open, and the High differential Pressure contacts (HdP) (34), also contained within the differential pressure switch, will be open. The controller's internal Relay (R) (36) will be de-energized. The solenoid valves for both valves [OV-SOV (20) and IV-SOV (18)] will be de-energized.

When it is desired to close the valve system and allow the process pressure to build, the logic system provides power to the device. At this time, the Inlet Valve Solenoid Operated Valve (IV-SOV) (18) will energize through the closed contacts OVFC_{bar} (part of 28) and R-ON_{bar} (part of 36) In its energized state, IV-SOV (18) will supply instrument air (16) to the actuator of IV (14) and the valve IV (12) will close. When the Inlet Valve IV (12) becomes fully closed, contacts IVFC (23) will close, and IVFC_{bar} (24) will be open. At this point in time, Inlet Valve IV (12) is closed and Outlet Valve OV (13) is open and any differential pressure between the process equipment and the vent/scrubber system will be felt across IV (12) and sensed by the differential pressure switch within the controller. As the differential pressure becomes sufficiently high, the High differential Pressure contacts (HdP) (34) will close, as will the NOT Low differential Pressure contacts (LdP_{bar}) (32). This is the normal, quiescent, non-cycling state. Should power be removed at any time, solenoid valve IV-SOV (18) will de-energize, venting the air from the actuator of IV (14), and IV (12) will open, releasing the pressure from the process equipment.

When it is desired to test the valve system for proper operation, (which test can only be performed while the process is under operation in the normal, quiescent, non-cycling state), the Permissive contacts (38) are closed. If sufficient differential pressure is present across IV (12), the High differential Pressure contacts (HdP) (34) will be closed. The closed Permissive contacts (38) will pass power to the Relay R (36) through the closed contacts IVFC (23), the closed contacts OVFO (26) and the closed contacts HdP (34). Relay R (36) will become energized, contacts R-ON_{bar} (part of 36) will open, and contacts R-ON (part of 36) will close, said R-ON (part of 36) contacts latching the Relay R (36) in the energized state through closed contacts LdP_{bar} (32) and the closed contacts IVFO_{bar} (22) in parallel with LdP_{bar} (32). The voltage across the Relay R (36) will also energize OV-SOV (20) through the forward biased diode D (42). OV-SOV (20) will energize, supplying instrument air (17) to the actuator (15) of valve OV and OV (13) will start to close. As OV (13) becomes fully closed, contacts OVFC (part of 28) will close and contacts OVFC_{bar} (part of 28) will open. At this point, contacts OVFC_{bar} (part of 28) are open and parallel contacts R-ON_{bar} (part of 36) are also open, causing IV-SOV (18) to become de-energized, venting the air from the actuator (14) for the Inlet Valve and IV (12) will start to open. As Inlet Valve IV (12) moves off of its fully closed stops, contacts IVFC_{bar} (24) will close and solenoid valve OV-SOV (20) will latch in the energized state through the closed contacts OVFC (part of 28) and IVFC_{bar} (24). As the Inlet Valve IV (12) reaches its fully open position, the contacts IVFO_{bar} (22) will open, and the Relay R (36) will maintain its energized state only through the closed contacts LdP_{bar} (32).

At this point, if the valve IV (12) has in fact opened, the differential pressure across IV (12) will be neutralized and will approach zero. As the differential pressure moves through the low dP trip point, contacts LdP_{bar} bar (32) will open and Relay R (36) will de-energize. [The voltage present across OV-SOV (20) will not maintain the Relay R (36) in the energized state due to the now reverse biased diode D (42)]. As Relay R (36) de-energizes, contacts R-ON (part of 36) will open and contacts R-ON_{bar} (part of 36) will close, providing power to solenoid valve IV-SOV (18). Energized IV-SOV (18) will supply instrument air (16) to the actuator of the Inlet Valve and IV (12) will start to close.

As IV (12) moves off of its fully opened stops, contacts IVFO_{bar} (22) will close. As IV (12) becomes fully closed, contacts IVFC (23) will close and contacts IVFC_{bar} (24) will open, removing power from OV-SOV (20). De-energized OV-SOV (20) will vent the air from the actuator (15) for the Outlet Valve and OV (13) will start to open. As OV (13) moves off of its fully closed stops, contacts OVFC (part of 28) will open and contacts OVFC_{bar} (part of 28) will close providing a second path for power to solenoid valve IV-SOV (18).

As the Outlet Valve OV (13) reaches its fully opened position, contacts OVFO (26) will close. At this point, if the Permissive contacts remain closed, the cycle will start again as above. However, if during any point in the cycle the Permissive Contacts (38) are opened, the cycle will terminate and the valve system will assume its normal, operational state. If, during any point of the cycle, power is removed from the valve system, both IV (12) and OV (13) will open, relieving the process pressure to the vent/scrubber system.

During one completed cycle, only the small amount of process fluid contained within the small interstitial volume between the two valve plugs (19) will be released into the venting system.

### Description of the Electronic Controller

The operation of the valve assembly of the instant invention with the Electronic Controller (100) will now be described, (see FIG. 3). With the electronic controller, the differential pressure is sensed by any standard, industrial, 24 vDC, 4-20 milliamp output, differential pressure transmitter [dPT (39) on FIG. 3]. The power for dPT (39) may be isolated from the power to the valve assembly, thereby allowing a control system or Programmable Logic Controller (PLC) to independently monitor the differential pressure across the Input Valve (IV) (12). This isolated transmitter will supply a 4 to 20 milliamp signal, an analog of the differential pressure, across the 20 ohm input Resistor Rᵢₙ (102), producing a 0.08 volt to 0.4 volt analog of the differential pressure. This voltage signal is in turn connected to a differential input operational amplifier (104) which, when Operating Power (200) [24 vDC] is applied to the controller (100), multiplies the differential voltage by a factor of 50, increasing the range to 4-20 vDC (106), a higher level analog of the differential pressure.

The Operating Power (200) (24 vDC) input supplies power to the various integrated circuits and components, and to a precision 20 vDC voltage regulator (110). This precision regulator provides reference voltage across two multi-turn potentiometers R_{THdP} (112) and R_{TLDP} (114) which are used to set the trip threshold voltages for the High differential Pressure logic signal HdP_{TP} (116) and the Low differential Pressure logic signal LdP_{TP} (117) respectively. Two single-supply differential comparitors reference the threshold voltages to the output of the operational amplifier to generate the signals HdP (120) and LdP (122).

Each valve, IV and OV (12, 13 on FIG. 1) inputs to the electronic controller a NOT Fully Open Limit Switch OVFO_{bar} (26) and IVFO_{bar} (22) and a NOT Fully Closed Limit Switch OVFC_{bar} (28) and IVFC_{bar} (24). Additionally, the controller has a permissive contact input PERM_{bar} (38). These contact inputs all close when TRUE, and each sinks the 5 vDC reference (124) to ground through current limiting resistors (126), generating their respective voltage equivalents OVFO_{bar} (26a) and IVFO_{bar} (22a), OVFC_{bar} (28a) and IVFC_{bar} (24a) and PERM_{bar} (38a). As such, these inputs are NOTed logic signals and are routed through an array of inverter circuits to produce the logic signals OVFO (128), OVFC (130), IVFO (132), IVFC (134) and PERM (136).

One side of each solenoid valve IV-SOV (18) and OV-SOV (20) is connected through the controller to the 24 vDC Operating Power supplied by the logic system. The alternate side of each solenoid valve is routed through a current sinking transistor circuit (138 & 139), each driven by the logic output of a two-input OR gate (140 & 142). The emitters of these driving transistors are each fed from a separate constant current generator (196 & 198) which limits the total current that can be provided to a SOV to 28 milliamps. The outlet valve solenoid valve OV-SOV (20) will be energized, and the outlet valve OV (13) closed, when either the controller is in Cycle Mode (CM) (144) OR when both the Outlet Valve Fully Closed signal (OVFC) (130) AND the Input Valve NOT Fully Closed signal (IVFC_{bar}) (24a) are TRUE. The inlet valve solenoid valve IV-SOV (18) will be energized, and the Inlet Valve IV (12) closed, whenever the NOT Cycle Mode signal (CM bar) (148) OR the Outlet Valve bar, NOT Fully Closed signal (OVFC_{bar}) (28a) is TRUE.

In the initial state, no power is supplied to the valve system from the logic output (see FIG. 3), and both valve ports and valves IV and OV (12 and 13) are opened. In this state, no process pressure can be established nor maintained above the pressure in the vent/scrubber system to which the valve system is connected. The Outlet Valve Fully Open contacts (OVFO_{bar}) (26) will be closed; the Outlet Valve Fully Closed contacts (OVFC_{bar}) (28) will be open. The Input Valve Fully Open contacts (IVFO_{bar}) (22) will be closed and the Inlet Valve Fully Closed contacts (IVFC_{bar}) (24) will be open. The controller circuits will not be powered.

When it is desired to close the valve system and allow the process pressure to build, the logic system provides power to the device (200). The electronic controller manages the Cycle Mode through the logic state of the D-type flip-flop circuit (180). The Cycle Mode is cleared by placing a logical FALSE signal on the Clear_{bar} (170) input of the Cycle Mode flip-flop. This signal is supplied by the action of a 2-input NOR gate (172). When power is first applied to the controller, the OVFO (128) and IVFO (132) logic signals will both be TRUE, the LdP (122) signal will be TRUE, and through the action of an AND gate (174) and said NOR gate (172), will clear the flip-flop and therefore set the Cycle Mode signal (CM) (140) to FALSE, correspondingly setting the NOT Cycle Mode Signal (CM_{bar}) (148) to TRUE. The signals OVFO (128) and IVFO (132) will be simultaneously TRUE only when power (200) is initially applied, and so this means of clearing the Cycle Mode flip-flop (180) is active only when power is first applied.

Immediately after Operating Power is applied to the controller, the NOT Cycle Mode logic signal (CM bar) (148) will be TRUE and the OVFC_{bar} (28a) signal will be TRUE, and bar, through the action of the OR gate (142) and the transistor driver circuitry (139), solenoid valve IV-SOV (18) will be energized and supply instrument air to the actuator (14) for valve IV and valve IV (12) will close. At this point the Cycle Mode (CM) (140) and the Outlet Valve Fully Closed (OVFC) (130) logic signals will be FALSE, so the solenoid valve OV-SOV (20) will remain de-energized and valve OV (13) will remain open. This is the normal, quiescent, non-cycling state. Should Operating Power (200) be removed at any time, solenoid valve IV-SOV (18) will de-energize, venting the air pressure from the actuator (14) of IV (12), and IV (12) will open, relieving the pressure from the process equipment.

When it is desired to test the valve system for proper operation, (which test can only be performed when the process is under operation in the normal, quiescent, non-cycling state), the Permissive contacts (38) are closed, causing the PERM_{bar} (38a) logic signal to be FALSE and the PERM (136) logic signal to be TRUE. Cycle Mode is set by placing a logical FALSE signal on the Preset_{bar} (182) input of the Cycle Mode flip-flop. This FALSE signal will be present whenever the signals PERM (136), OVFO (128), IVFC (134) and HdP (120) are TRUE. These logical signals are first ANDed together through an array of 2-input AND gates (184, 186 & 188), and then NOTed in an inverter (190). In the NOT Cycle Mode State [i.e. the signal CM_{bar} (148) is TRUE], the Inlet Valve (IV) (12) will be closed and the Outlet Valve (OV) (13) will be open, so the signals OVFO (128) and IVFC (134) will both be TRUE. If sufficient differential pressure is present across the Inlet Valve (IV) (12) to exceed the threshold as set by R_{THdP} (112), then logic signal HdP (120) will be TRUE and all conditions will be met to set the flip-flop (180) output CM (140) to TRUE, while the corresponding output CM_{bar} (148) is set to FALSE.

The TRUE CM (140) signal at the input of the OV-SOV OR gate (140) will energize solenoid valve OV-SOV (20), which will in turn supply instrument air (17) to the actuator (15) of the Outlet Valve, and OV (13) will start to close. While OV (12) is not fully closed, the TRUE state of the Outlet Valve NOT Fully Closed signal (OVFC_{bar}) (128) will hold the solenoid valve IV-SOV (18) in its energized state, and IV (12) will remain closed. As OV (13) moves off of its full open stop, contacts OVFO_{bar} (26) will open and the logic signal OVFO (128) will become FALSE. When the Outlet Valve (13) becomes fully closed, contacts OVFC_{bar} (28) will close and signal OVFC_{bar} (28a) will become FALSE and correspondingly, logic signal OVFC (130) will become TRUE.

During this Cycle Mode [i.e. while the signal CM_{bar} (148) is FALSE], once the logic signal OVFC_{bar} (28) becomes FALSE, both inputs of the IV-SOR (18) OR gate (142) will be FALSE and IV-SOR (18) will de-energize, venting the air pressure from the actuator (14) of the Inlet Valve and IV (12) will open. As IV (12) moves off of its fully closed stop, contacts IVFC_{bar} (24) will open. At this point in time, the logic signal IVFC_{bar} (24a) will become TRUE and correspondingly, logic signal IVFC (134) will become FALSE. The two TRUE signals OVFC (130) and IVFC_{bar} (24a) through the operation of an AND gate (192) and the OV-SOV (20) OR gate (140), will seal the solenoid valve OV-SOV (20) in its energized state. As the IV (18) assumes its fully opened state, contacts IVFO_{bar} (22) will close and the logic signal IVFO (132) will become TRUE.

At this point, if the valve IV (12) has in fact opened, the differential pressure across IV (12) will be neutralized and will approach zero. As the differential pressure moves through the low dP threshold as established by R_{TLdP} (114), the logic signal LdP (122) will become TRUE, and through the action of the NOR gate (172), will clear the Cycle Mode state of the flip-flop (180); the logic signal CM (140) will become FALSE, and the corresponding signal CM_{bar} (148) will become TRUE.

When the CM_{bar} (148) signal becomes TRUE, the output of the OR gate (142) will become TRUE, the solenoid valve IV-SOV (18) will become energized, and supply instrument air to the actuator (14) of the Inlet Valve, and IV (12) will start to close. Until IV (12) becomes fully closed, the ANDed logic signals OVFC (130) and IVFC_{bar} (24a) will both remain TRUE and will hold the solenoid valve OV-SOV (20) in its energized state through the action of its transistor drive circuit (138). As IV (12) moves off of its fully opened stop, contacts IVFO_{bar} (22) will open, and logic signal IVFO (132) will become FALSE. As IV (12) becomes fully closed, the contacts IVFC_{bar} (24) will close, the logic signal IVFC_{bar} (24a) will become FALSE, and the signal IVFC (134) will become TRUE. When the signal IVFC_{bar} (24a) becomes FALSE, solenoid valve OV-SOV (20) will de-energize, venting the air pressure from the actuator (15) and OV (13) will open. As OV (13) moves off of its fully closed stop, contacts OVFC_{bar} (28) will open, the logic signal OVFC_{bar} (28a) will become TRUE, and the corresponding logic signal OVFC (130) will become FALSE. As OV (13) becomes fully open, contacts OVFO_{bar} (26) will close and the logic signal OVFO (128) will become TRUE.

At this point in time, if the PERM_{bar} (38) contacts remain closed, the cycle will again be initiated as above. If, during any point of the cycle, Operating Power (200) is removed from the valve system, both IV (12) and OV (13) will open, relieving the process pressure to the vent/scrubber system, or otherwise allowing process fluid to flow.

All functions described above for the electronic controller can also be executed by means of a configuration program installed within a Programmable Logic Controller or any other safety rated programmable electronic device.

### Description Common to Both Controller Types

During each cycle, the amount of process fluid allowed to escape into the vent/scrubber system is limited by the small volume of the interstitial space (19) between the plugs of the Inlet Valve (IV) (12) and the Outlet Valve (OV) (13).

The cycling of the instant valve assembly (40) may be monitored by visual inspection of the valve assembly (40) while cycling, by monitoring the release of air pressure from either or both of the actuators (14 and/or 15), by configuring the logic system so that the varying current supplied to the assembly can be sensed, by adding a switched voltage output signal to the electronic controller, driven by the Cycle Mode (CM) (140) output of the flip-flop (180), or by providing auxiliary contacts on the Relay R (36) in the electro-mechanical controller and connecting these contacts to the logic system or to a remotely mounted lamp. The monitored cycle will be interrupted by any of the following conditions: Failure of the plug or stem of either valve IV (12) or OV (13); Blockage of the plug or either valve IV (12) or OV (13); Failure of either solenoid IV-SOV (18) or OV-SOV (20); Failure of the Instrument Air Supply (16 and/or 17); Failure of any component of the differential pressure switch, when utilizing the electro-mechanical controller; Failure of the differential pressure transmitter (39), when utilizing the electronic controller or a Programmable Logic Solver; Blockage of either or both of the differential pressure sensing ports; Failure (Opened or Shorted) of any of the valve position limit switches on either valve; Any failure in the wiring or any internal controller component (electro-mechanical, electronic, or Programmable Logic Solver) within the Fail Open Block Valve System; Any failure in the wiring between the valve system and the logic input or output; Failure of the power output circuit from the logic system; Failure of the input circuit within the logic system; Blockage of the piping between the process equipment and the Inlet Valve IV when used in a pressure relief system; Blockage of the piping between the Outlet Valve OV and the vent/scrubber system when used in a pressure relief system; and Pressurization of the vent/scrubber system when used in a pressure relief system.

Accordingly, the Fail Open Valve System of the present invention can continuously check for the proper operation of the entire pressure relief system and detects any type of failure of the system, all while the process is in operation.

The external permissive contacts allow for the periodic checking of the pressure relief system, while allowing the system to be held in its quiescent state for the majority of the time between which testing is required. Otherwise there may be unnecessary wear and tear on the valves. Additionally, devices can be added to the system to provide for the adjustment of the frequency of the opening and closing of the valves. Means to adjust the frequency of the cycle include placing restrictions on the air supply ports and/or vent ports of the valve actuators, installing a resistive/capacitive network in parallel with the relay in the electro-mechanical controller, installing a time delay circuit in the solenoid valve output circuits of the electronic controller, or installing restrictions in the differential pressure sensing ports to restrict the speed with which the differential pressure can be sensed.

It is intended that the foregoing detailed description be regarded as illustrative rather than limiting, that the applications of the fail open block valve system is not limited to the applications used for illustration, and that it is understood that the following claims including all equivalents are intended to define the scope of the invention.

What is claimed is:

1. A cycling self checking, fail open valve system comprising;
two valves in series, connected to and enclosing a small volume between the outlet of the inlet valve, and the inlet of the outlet valve,
means to alternately open and close said two valves with one valve always in the fully closed position, whereby in the first half-cycle the outlet valve fully closes and then the inlet valve opens, allowing process pressure to be established in the interstitial volume, and then in the second half-cycle the inlet valve closes and the outlet valve reopens, allowing the pressure in the interstitial volume to drop to the pressure of the venting system,
means to sense the presence or absence of a pressure difference between the process system and the said interstitial volume located between the said two valves,
means to allow the presence of a pressure difference to force the initiation of the first half-cycle, and the absence of a pressure difference to force the initiation of the second half-cycle, and
means to recognize and monitor irregularities in the cycles of said valve opening and closings.

2. A cycling self checking fail open valve system as in claim 1, wherein a failure of the means to alternately open and close said two valves and to repeat continuously the alternate opening and closing of said two valves will create an irregularity in the cycle of said valve opening and closings.

3. A cycling self checking fail open valve system as in claim 1 wherein said means to recognize and monitor irregularities comprises a computer that is programmed to recognize irregularities in the cycles of said valve opening and closings.

4. A cycling self checking fail open valve system as in claim 1 wherein said means to alternately open and close said two valves comprises,
Independently driven actuators on each of said two valves, and
Full open sensors on each of said valves whereby it is determined when each of said two valves are fully open, and
Full closed sensors on each of said two valves whereby it is determined when each of said two valves are fully closed.

5. A cycling self checking fail open valve system as in claim 4 wherein said means to alternately open and close said two valves further comprises a differential pressure switch that senses when there is a pressure difference between the process pressure and the pressure within the interstitial volume enclosed between the outlet of the inlet valve and the inlet of the outlet valve.

6. A cycling self checking fail open valve system as in claim 5 wherein signals from said differential pressure switch and said full open sensors and said full closed sensors interact to coordinate said means to alternately fully open and fully close said two valves.

7. A cycling self checking fail open valve system as in claim 4 wherein said means to alternately open and close said two valves further comprises a differential pressure transmitter with associated electronic circuitry that senses when there is a pressure difference between the process pressure and the pressure within the interstitial volume enclosed between the outlet of the inlet valve and the inlet of the outlet valve.

8. A cycling self checking fail open valve system as in claim 7 wherein signals from said differential pressure transmitter and associated circuitry and said full open sensors and said full closed sensors interact to coordinate said means to alternately fully open and fully close said two valves.

9. A cycling self checking fail open valve system as in claim 1 further comprising means to adjust the frequency of the application of said means to alternately open and close said two valves.

10. A cycling self checking fail open valve system as in claim 1 further comprising means to permit or prevent the application of said means to alternately fully open and fully close said two valves.

11. A process for continuously monitoring the operation of the valve system, comprising the steps of;
Connecting two valves, both of said two valves located in series in the same stream,
with the upstream valve to be the inlet valve and the downstream valve to be the outlet valve, and with a small volume to be enclosed between the outlet of the inlet valve and the inlet of the outlet valve,
alternately opening and closing said two valves, whereby during the first half-cycle the outlet valve fully closes and once fully closed the inlet valve fully opens, and then during the second half-cycle the inlet valve fully closes and once fully closed the outlet valve fully opens,
repeating continuously the alternate opening and closing of said two valves, and
recognizing and monitoring irregularities in the cycles of said valve full openings and full closings.

12. A cycling self checking valve system comprising;
A pipe body with single inlet and single outlet, said pipe body supplying the input to the
inlet valve, the enclosed interstitial volume between the outlet of the inlet valve and the inlet of the outlet valve,
an upstream valve to function as the inlet valve and a downstream valve to function as the outlet valve,
means to alternately open and close said two valves and to repeat continuously the alternate opening and closing of said two valves, whereby first the said outlet valve fully closes and when fully closed, the inlet valve will fully open, and then the inlet valve will fully close and when fully closed the outlet valve will fully open,
means to recognize and monitor irregularities in the cycles of said valve opening and closings.

13. A cycling self checking fail open valve system as in claim 12, wherein a failure of the means to alternately fully open and fully close said two valves and to repeat continuously the alternate fully opening and fully closing of said two valves will create an irregularity in the cycle of said valve opening and closings.

14. A cycling self checking fail open valve system as in claim 12, wherein said means to recognize and monitor irregularities comprises a computer or programmable logic controller that is programmed to recognize irregularities in the cycles of said valve opening and closings.

15. A cycling self checking fail open valve system as in claim 12, wherein said means to alternately open and close said two valves comprises,
Independently driven actuators on each of said two valves, and
Full open sensors on each of said two valves whereby it is determined when each of said two valves are fully open, and
Fully closed sensors on each of said two valves whereby it is determined when each of said two valves are fully closed.

16. A cycling self checking fail open valve system as in claim 15 wherein said means to alternately open and close said two valves further comprises a differential pressure switch that senses the presence or absence of a pressure difference between the inlet of the inlet valve and the enclosed interstitial volume between the outlet of the inlet valve and the inlet of the outlet valve.

17. A cycling self checking fail open valve system as in claim 16 wherein signals from said differential pressure switch and said full open sensors and said full closed sensors interact to coordinate said means to alternately open and close said two valves.

18. A cycling self checking fail open valve system as in claim 12 further comprising means to adjust the frequency of the application of said means to alternately open and close said two valves.

19. A cycling self checking fail open valve system as in claim 12 further comprising means to permit or prevent the application of said means to alternately open and close said two valves.

20. A cycling self checking fail open valve system as in claim 15 wherein said means to alternately open and close said two valves further comprises a differential pressure transmitter with associated electronic circuitry that senses the presence or absence of a pressure difference between the inlet of the inlet valve and the enclosed interstitial volume between the outlet of the inlet valve and the inlet of the outlet valve.

21. A cycling self checking fail open valve system as in claim 15 wherein said means to alternately open and close said two valves further comprises a differential pressure transmitter with associated electronic circuitry that senses the presence or absence of a pressure difference between the inlet of the inlet valve and the enclosed interstitial volume between the outlet of the inlet valve and the inlet of the outlet valve.

22. A cycling self checking fail open valve system as in claim 21 wherein the signals from said differential pressure transmitter with its associated electronic circuitry and said full open sensors and said full closed sensors interact to coordinate said means to alternately fully open and fully close said two valves.
